(19) United States
(12) Patent Application Publication
(10) Pub. No.: US 2014/0059879 A1
(43) Pub. Date: Mar. 6, 2014

(54) USE OF NITROGEN GAS IN THAWING PLATES IN A LiN-BASED LYOPHILIZATION UNIT

(71) Applicant: Sudhir R. BRAHMBHATT, Glencoe, MO (US)

(72) Inventor: Sudhir R. BRAHMBHATT, Glencoe, MO (US)

(73) Assignee: Air Liquide Industrial U.S. LP, Houston, TX (US)

(21) Appl. No.: 13/601,346

(22) Filed: Aug. 31, 2012

(51) Int. Cl. F26B 5/06; F26B 19/00

(52) U.S. Cl. 34/287; 34/92; 34/89

(57) ABSTRACT

This work is in simplifying the freezing and heating process required for a typical lyophilization process. From a liquid nitrogen supply tank called LIN tank, calculated quantity of vaporized nitrogen is transported the use point where a heater that uses heating media heats up nitrogen to a desired temperature and pass into the annular space of the steel plate where lyophilized solvent such as water of solvent is deposited on the outer surface of the plate. The heated nitrogen temperature will dictate the rate at which the solvent or water will be thawed. This unique process offer simplicity, safety and ease operation allowing the user to avoid heating oil as heating media, a common practice in the industry.

### TECHNICAL FIELD

The invention relates to lyophilization procedures.

### BACKGROUND ART

Biological materials often must be dried to stabilize them for storage or distribution. Drying always causes some loss of activity or other damage. Lyophilization, also called freeze-drying, is a method of drying that significantly reduces such damage. Because lyophilization is the most complex and expensive form of drying, its use is usually restricted to delicate, heat-sensitive materials of high value.

Substances that are not damaged by freezing can usually be lyophilized so that refrigerated storage is unnecessary. An important exception is the case of mammalian cells, nearly all of which are destroyed by lyophilized. Many microorganisms and proteins survive lyophilization well, and it is a favored method of drying vaccines, pharmaceuticals, blood fractions, and diagnostics. Some specialist food products are also lyophilized. They rehydrate easily and quickly because of the porous structure left after the ice has sublimed. Occasionally materials are lyophilized to achieve a porous, friable structure rather than for preservation. Lyophilizers are sometimes used for concentration of delicate materials.

The typical lyophilization system includes a chamber in which the products to be lyophilized (or synonymously, “freeze-dried”) are placed on shelves. The shelves are heated and cooled. In a typical lyophilization cycle, the chamber is first filled with the product and closed. The air is replaced with dry air and the freezing step begins. A mechanical refrigeration or similar system provides necessary cooling and brings the chamber temperature to freezing temperature so water is frozen to ice. Next the chamber atmosphere pressure is reduced (generally by a vacuum pump) so that the boiling point of liquid in the products is significantly lower. When small amount of heat is provided to the shelves by circulating heated silicon oil, the heating results in ice formed during the refrigeration step sublimating to water vapor. The water vapor is conveyed to the refrigeration unit by a vacuum step, where it condenses on a refrigeration coil, and can then be easily removed as liquid water.

Lyophilization is a means of drying, achieved by freezing a wet substance and causing the ice to sublime directly to vapor by exposing it to a low partial pressure of water vapor. In practice the substance may not be completely frozen, especially if nonaqueous solutions are present, and most lyophilization processes are followed by a period of desorption drying.

There is an increasing need for Lyophilization of biotech and pharma products as these industries optimize production to increase profits in a competitive market. At the same time, with dual effect:
HCFC Phase out schedule requiring to shut down the production of and import of HCFC 142b and HCFC-22 by 2010,
Higher demand for Lyophilization units as more contract manufacturers are set up to offer services to the Biotech industry,

Efforts are being made in the industry to find out the ways to improve the lyophilization operation, find ways to eliminate use of HCFCs refrigerants, and also optimize the lyophylization operation so more batches are carried with better quality results. Freeze dried biotech products are normally expensive and their quality is critical for the shelf life and the potency of the product. The high maintenance cost of mechanical lyophilization units is due to use of a large number of rotating and mechanical components and majority of the maintenance is related to the refrigeration unit and the leak of refrigerant. These problems inherent in the current technology are important cost drivers and reduce overall productivity.

In a typical lyophilization system, the product is cooled to very low temperature to freeze water, and/or organic solvents in the product need to be crystallized for lyophylization. These crystals need to be sublimed or vaporized under vacuum conditions. This requires heating the product to boiling point using heating oil in the annular space of plates holding the product. This heating oil requires a specific pump, and in case of openings or overfill, the product will be exposed to significant heating oil contamination.

### SUMMARY OF INVENTION

This disclosure offers two significant benefits:
In a standard Lyophilization or freeze drying operation, nitrogen becomes the heating media in place of oil. Gaseous nitrogen travels to the use point heat exchanger and necessary heat is supplied to raise the temperature of nitrogen and provide necessary heat to the trays or plates in liquefying and/or subliming product solvent.
This offers unique advantage of reusing the nitrogen for blanketing and inerting processes once it is used in the lyophylization process; thus allowing optimized use of nitrogen and thereby reduce the cost of operations.

As an alternative to the heating oil or similar heating media, new work offers a cost effective and safe solution to the conventionally used method. In an example of the proposed solution:
From a typical liquid nitrogen tank (Industrial and/or medical grade Nitrogen), nitrogen is vaporized to the ambient temperature and is then transported to the use point.
At the Point of use, a trim heater allows the user to decide on the temperature that will dictate the time required to liquefy or sublime the solvent from the tray or the metal surface.
In this configuration, the same delivery piping used for liquid nitrogen for the freezing step is used to deliver the gaseous nitrogen heating medium.

This method offers following advantages over know methods:
The user has a cost saving solution as used nitrogen can be reused as an inerting product atmosphere downstream in the production process, thus allowing the user to get double use of nitrogen
This solution is much safer alternative than is available today in case of unexpected operational issues. For example, heating oil, in case of pipe rupture or opening of weld in case of seamed piping, can present a major problem and expensive batch will have to be discarded and this may result in million dollars worth losses.
It is environmentally friendly solution as no CFC's are used to refrigerate and it helps reduce the carbon foot print of the overall process.

The invention may be further understood in relation to the following numbered sentences:
1. An apparatus for lyophilizing materials (10), the apparatus comprising:
   a) A freeze/thaw unit (90),
   b) A source of liquid nitrogen (20, 70) in fluid communication (80) with the freeze/thaw unit (90),
   c) A source of gaseous nitrogen (130,70) in fluid communication (135) with the freeze/thaw unit (90), the fluid communication including a trim heat exchanger (140) in a fluid flow position between the source of gaseous nitrogen (130,70) and the freeze/thaw unit (90),
   d) A first freeze/thaw unit vent line (100) configured to remove nitrogen gas from the freeze/thaw unit (90).
2. The apparatus of sentence 1 further comprising a plate (30) or tray (40) within the freeze/thaw unit (90), the plate (30) or tray (40) is configured to hold a product (50, 60) intended for a lyophylization process; and wherein the plate (30) or tray (40) further comprises a heat transfer conduit therethrough and in fluid communication (80; 135) with both the source of gaseous nitrogen (130,70) and the source of liquid nitrogen (20, 70); and wherein the heat transfer conduit is configured to permit heat exchange between liquid nitrogen (20, 70) and gaseous nitrogen (130,70) within the heat transfer conduit and the product (50, 60) intended for a lyophylization process.
3. The apparatus of sentence 1 or 2, further comprising a storage freezer (110) in fluid communication with the freeze/thaw unit vent line (100), the storage freezer (110) comprising an freezer vent (120) configured to remove nitrogen gas from the storage freezer (110).
4. The apparatus of sentence 1, 2, or 3, further comprising a second freeze/thaw unit vent line (150) configured to transport from the freeze/thaw unit (90) whereby the gaseous nitrogen is supplied to a product inerting or blanketing atmosphere.
5. The apparatus of sentence 1, 2, 3 or 4, further comprising a liquid nitrogen metering valve (85) in fluid communication (80) and in a fluid flow position between the source of liquid nitrogen (20, 70) and the freeze/thaw unit (90).
6. The apparatus of sentence 1, 2, 3, 4 or 5, further comprising a gaseous nitrogen metering valve (145) in fluid communication (135) and in a fluid flow position between the source of gaseous nitrogen (130, 70) and the trim heat exchanger (140).
7. The apparatus of sentence 1, 2, 3, 4, 5 or 6, further comprising a bypass valve (160) in fluid communication with
   a) the source of gaseous nitrogen (130, 70, 135, 140, 145),
   b) the source of liquid nitrogen (20, 70, 85, 80), and
   c) the freeze/thaw unit (90),
      wherein the bypass valve (160) is configured to receive and alternate between emitting to the freeze/thaw unit (90) only one at a time of the liquid nitrogen or the gaseous nitrogen.
8. The apparatus of sentence 2, 3, 4, 5, 6 or 7, further comprising a temperature sensor (170) configured to measure the temperature of a product (50, 60) on a plate (30) or in a tray (40).
9. The apparatus of sentence 1, 2, 3, 4, 5, 6, 7 or 8, wherein the source of liquid nitrogen (20, 70) and the source of gaseous nitrogen (130, 70) is the same source (70).
10. The apparatus of sentence 1, 2, 3, 4, 5, 6, 7, 8 or 9, wherein the freeze/thaw unit (90) is configured to receive only liquid nitrogen liquid nitrogen (20, 70, 85, 80, 160) as a product freezing medium and only gaseous nitrogen (130, 70,135, 140, 145, 160) as a product thawing medium.
11. A method of lyophilizing a product comprising the steps of:
   a) Freezing the product by placing the product in a thermal communication with a liquid nitrogen to thereby form a frozen product,
   b) Thawing the product by placing the product a thermal communication with a gaseous nitrogen having a temperature higher than the frozen product of step a) to thereby form a thawed product,
   c) Applying a vacuum pressure to the thawed product to thereby remove a water vapor or a solvent vapor released by the thawed product during or after step b).
12. The method of sentence 11 further comprising a sub-step b) A) of adjusting the temperature of the gaseous nitrogen prior to thawing the product, whereby the temperature of the gaseous nitrogen is made suitable to thaw the product in a defined period of time to thereby optimize the removal of water vapor or solvent vapor in step c).
13. The method of sentence 12, wherein the sub-step b) A) of adjusting the temperature of the gaseous nitrogen is performed in a trim heat exchanger.
14. The method of sentence 11, 12, 13, further comprising the step of removing the gaseous nitrogen after step b) and applying the gaseous nitrogen as an inerting or blanketing atmosphere to a product which has been previously lyophilized.
15. The method of sentence 11, 12, 13 or 14, further comprising the step of removing the gaseous nitrogen formed during step a) and applying the gaseous nitrogen as a cooling medium to a product in storage.

### DISCLOSURE OF INVENTION

The present work focuses on the use of gaseous nitrogen instead of heat transfer fluid or heating oil that is normally used in liquefying or subliming the solvent from the product. The system thus uses liquid nitrogen as the refrigerant and generally gaseous nitrogen from the same source as the heating medium. The heated Nitrogen gas may then be recycled and/or used as an inerting atmosphere.

### BRIEF DESCRIPTION OF DRAWINGS

FIG. 1 shows a diagram of an embodiment of a device adapted for carrying out the invention according to a specific process embodiment.

### MODE(S) FOR CARRYING OUT THE INVENTION

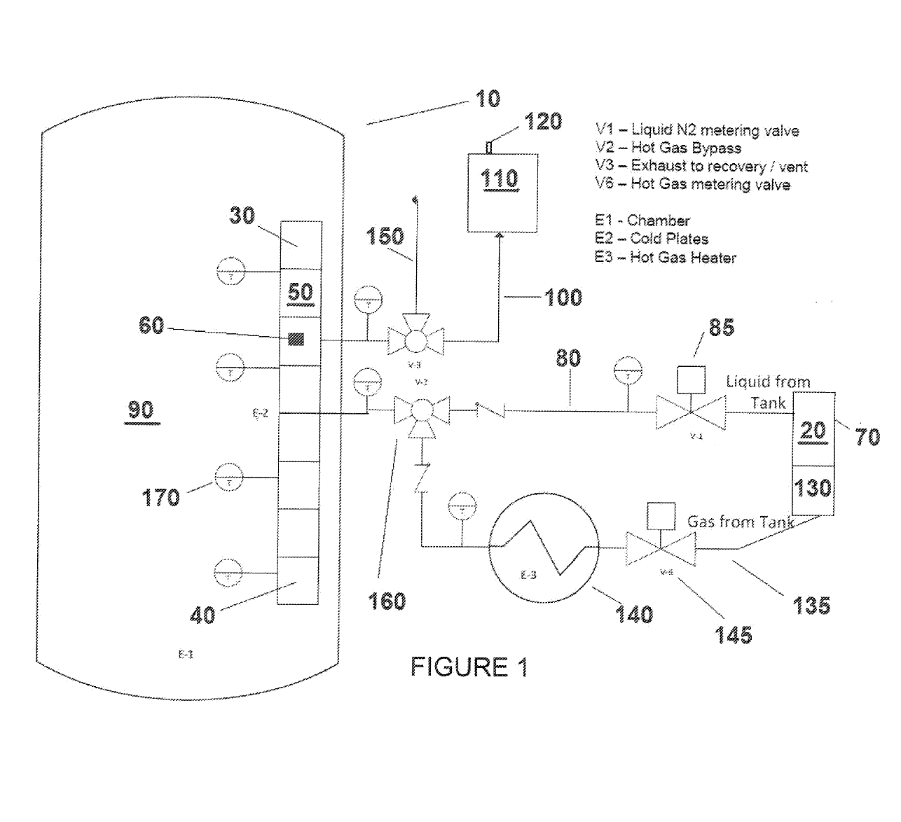

An embodiment of the invention is shown in FIG. 1. In this lyophilization system 10, liquid nitrogen 20 is used in lieu of chlorofluorocarbon refrigerants to cool down the plates 30 or trays 40 that contain the product 50 in vials 60 or any other suitable container. Liquid nitrogen 20 from the supply tank 70 is supplied through the appropriate piping 80 to the freezing/thaw unit 90 at a controlled rate based on the plate 30 or tray 40 surface temperature. Generally the piping 80 is fluidly connected to a heat transfer conduit passing through the plate 30 or tray 40 thus maintaining the liquid nitrogen isolated from the product 50.

During the use of liquid nitrogen, the cold exhaust 100 is directed to a product storage freezer 110 to further utilize the cold temperature gas as a refrigerant prior to releasing the exhaust 120 at ambient temperatures.

Upon completion of the freezing cycle, liquid nitrogen flow is stopped. At a specific time a gaseous nitrogen flow 130 from the same supply tank 70 is sent to a trim heat exchanger 140, for example an electric trim heat exchanger, that raises the gaseous nitrogen flow 130 to a temperature that is based on the process vaporization or thawing time at the plate 30 or tray 40. The gaseous nitrogen flow 130 then generally passes through a heat transfer conduit passing through the plate 30 or tray 40, thus maintaining the gaseous nitrogen isolated from the product 50. The warm exhaust nitrogen 150 from the freezing/thaw unit 90 is then directed to a blanketing or inerting use downstream in the manufacturing process.

### INDUSTRIAL APPLICABILITY

The present invention is at least industrially applicable to lyophilization of biological materials such fermentable microorganisms.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

An references identified herein are each hereby incorporated by reference into this application in their entireties, as well as for the specific information for which each is cited.

1. An apparatus for lyophilizing materials (10), the apparatus comprising:
a) a freeze/thaw unit (90),
b) a source of liquid nitrogen (20, 70) in fluid communication (80) with the freeze/thaw unit (90),
c) a source of gaseous nitrogen (130,70) in fluid communication (135) with the freeze/thaw unit (90), the fluid communication including a trim heat exchanger (140) in a fluid flow position between the source of gaseous nitrogen (130,70) and the freeze/thaw unit (90),
d) a first freeze/thaw unit vent line (100) configured to remove nitrogen gas from the freeze/thaw unit (90).

2. The apparatus of claim 1, further comprising a plate (30) or tray (40) within the freeze/thaw unit (90), the plate (30) or tray (40) is configured to hold a product (50, 60) intended for a lyophylization process; and wherein the plate (30) or tray (40) further comprises a heat transfer conduit therethrough and in fluid communication (80; 135) with both the source of gaseous nitrogen (130,70) and the source of liquid nitrogen (20, 70); and wherein the heat transfer conduit is configured to permit heat exchange between liquid nitrogen (20, 70) and gaseous nitrogen (130,70) within the heat transfer conduit and the product (50, 60) intended for a lyophylization process.

3. The apparatus of claim 1, further comprising a storage freezer (110) in fluid communication with the freeze/thaw unit vent line (100), the storage freezer (110) comprising an freezer vent (120) configured to remove nitrogen gas from the storage freezer (110).

4. The apparatus of claim 1, further comprising a second freeze/thaw unit vent line (150) configured to transport from the freeze/thaw unit (90) whereby the gaseous nitrogen is supplied to a product inerting or blanketing atmosphere.

5. The apparatus of claim 1, further comprising a liquid nitrogen metering valve (85) in fluid communication (80) and in a fluid flow position between the source of liquid nitrogen (20, 70) and the freeze/thaw unit (90).

6. The apparatus of claim 1, further comprising a gaseous nitrogen metering valve (145) in fluid communication (135) and in a fluid flow position between the source of gaseous nitrogen (130, 70) and the trim heat exchanger (140).

7. The apparatus of claim 1, further comprising a bypass valve (160) in fluid communication with
a) the source of gaseous nitrogen (130, 70, 135, 140, 145),
b) the source of liquid nitrogen (20, 70, 85, 80), and
c) the freeze/thaw unit (90),
wherein the bypass valve (160) is configured to receive and alternate between emitting to the freeze/thaw unit (90) only one at a time of the liquid nitrogen or the gaseous nitrogen.

8. The apparatus of claim 2, further comprising a temperature sensor (170) configured to measure the temperature of a product (50, 60) on a plate (30) or in a tray (40).

9. The apparatus of claim 1, wherein the source of liquid nitrogen (20, 70) and the source of gaseous nitrogen (130, 70) is the same source (70).

10. The apparatus of claim 1, wherein the freeze/thaw unit (90) is configured to receive only liquid nitrogen liquid nitrogen (20, 70, 85, 80, 160) as a product freezing medium and only gaseous nitrogen (130, 70, 135, 140, 145, 160) as a product thawing medium.

11. A method of lyophilizing a product comprising the steps of:
a) freezing the product by placing the product in a thermal communication with a liquid nitrogen to thereby form a frozen product,
b) thawing the product by placing the product a thermal communication with a gaseous nitrogen having a temperature higher than the frozen product of step a) to thereby form a thawed product,
c) applying a vacuum pressure to the thawed product to thereby remove a water vapor or a solvent vapor released by the thawed product during or after step b).

12. The method of claim 11, further comprising a sub-step b) A) of adjusting the temperature of the gaseous nitrogen prior to thawing the product, whereby the temperature of the gaseous nitrogen is made suitable to thaw the product in a defined period of time to thereby optimize the removal of water vapor or solvent vapor in step c).

13. The method of claim 12, wherein the sub-step b) A) of adjusting the temperature of the gaseous nitrogen is performed in a trim heat exchanger.

14. The method of claim 11, further comprising the step of removing the gaseous nitrogen after step b) and applying the gaseous nitrogen as an inerting or blanketing atmosphere to a product which has been previously lyophilized.

15. The method of claim 11, further comprising the step of removing the gaseous nitrogen formed during step a) and applying the gaseous nitrogen as a cooling medium to a product in storage.
